(19) United States
(12) Patent Application Publication
(10) Pub. No.: US 2016/0217451 A1
(43) Pub. Date: Jul. 28, 2016

(54) CHARGING PROCESSING DEVICE AND CHARGING PROCESSING METHOD

(71) Applicant: FUJITSU LIMITED, Kawasaki-shi (JP)

(72) Inventor: Tetsuharu Sakurai, Yokohama (JP)

(73) Assignee: FUJITSU LIMITED, Kawasaki-shi (JP)

(21) Appl. No.: 14/960,543

(22) Filed: Dec. 7, 2015

(30) Foreign Application Priority Data
Jan. 28, 2015 (JP) 2015-014717

(51) Int. Cl. G06Q 20/28; G06Q 20/14; H04L 12/14; G06Q 40/00

(52) U.S. Cl. CPC G06Q 20/28; G06Q 40/12; G06Q 20/145; H04L 12/1403

(57) ABSTRACT

A charging processing device includes: a storage configured to store therein remainder information that represents the remainder with respect to a usable amount of service; and a processor configured to execute a charging process. The charging process includes: updating the remainder information according to the usage amount of the service, and controlling a timing of the next update on the basis of the updated remainder information.

### CROSS-REFERENCE TO RELATED APPLICATION

This application is based upon and claims the benefit of priority of the prior Japanese Patent Application No. 2015-14717, filed on Jan. 28, 2015, the entire contents of which are incorporated herein by reference.

### FIELD

The embodiments discussed herein are related to a charging processing device, a charging processing method, and a charging processing program.

### BACKGROUND

There is a cloud service in which a service provider provides, for example, software or hardware resources to a user via a communication network.

One of the charging methods for a cloud service is a prepaid charging method. In the prepaid charging method, a user of a cloud service charges (adds money for) a fee for using the service in advance, and the service can be used until the balance is exhausted. In this method, when a user uses a service, an amount of money according to the usage is deducted from a charged amount (prepaid balance).

Regarding the prepaid charging method for a cloud service, there is a prepaid charging system in which use of a cloud computing service is charged by use of a data center. The prepaid charging system stores data of a prepaid balance for each user in a database. Next, for a user who was connected to a virtual server that serves as a data center via a network, the prepaid charging system calculates a charge according to the usage amount of a cloud computing service. Then, the prepaid charging system updates, with the calculated charge, the prepaid balance of the user that is stored in the database, and performs a control for discontinuing communication between the user and the virtual server when the prepaid balance of the user is less than zero.

The technology that is disclosed in each of the following documents is known:

### Japanese Laid-open Patent Publication No. 2013-15986

### Japanese Laid-open Patent Publication No. 2007-159298

### Japanese Laid-open Patent Publication No. 2009-240049

### SUMMARY

According to an aspect of the embodiment, a charging processing device includes: a storage configured to store therein remainder information that represents the remainder with respect to a usable amount of service; and a processor configured to execute a charging process. The charging process includes: updating the remainder information according to the usage amount of the service, and controlling a timing of the next update on the basis of the updated remainder information.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a block diagram that illustrates an example of a charging processing device according to an embodiment of the present invention;

FIG. 2 is a block diagram that illustrates charging processing according to a comparative example;

FIG. 3 is a graph that illustrates a case in which the amount of money used for the service exceeds a prepaid balance according to the comparative example;

FIG. 4 is a block diagram that illustrates charging processing according to the embodiment;

FIG. 5 is a graph that illustrates a prevention of excess usage according to the embodiment;

FIG. 6 is a block diagram that illustrates an example of a charging processing system according to the embodiment;

FIG. 7 is a table that illustrates an example of resource information;

FIG. 8 is a table that illustrates an example of system information;

FIG. 9 is a table that illustrates an example of user information;

FIG. 10 is a table that illustrates an example of charging information;

FIG. 11 is a table that illustrates an example of metering information;

FIG. 12 is a flowchart that illustrates in detail an example of processing performed by the charging processing device according to the embodiment; and

FIG. 13 is block diagram that illustrates an example of a hardware configuration of the charging processing device according to the embodiment.

### DESCRIPTION OF EMBODIMENTS

In the prepaid charging method mentioned above, a prepaid balance is updated at regular intervals. For example, there is a possibility that a prepaid balance is reduced to zero between consecutive update points for the prepaid balance and becomes negative at the next update point. Thus, when using the technology mentioned above, there is a possibility that a user uses a service exceeding a prepaid amount because an update timing for a prepaid balance has not been considered.

In a charging processing device according to an embodiment of the present invention, it is possible to optimize an update timing for the remainder with respect to a usable amount of service.

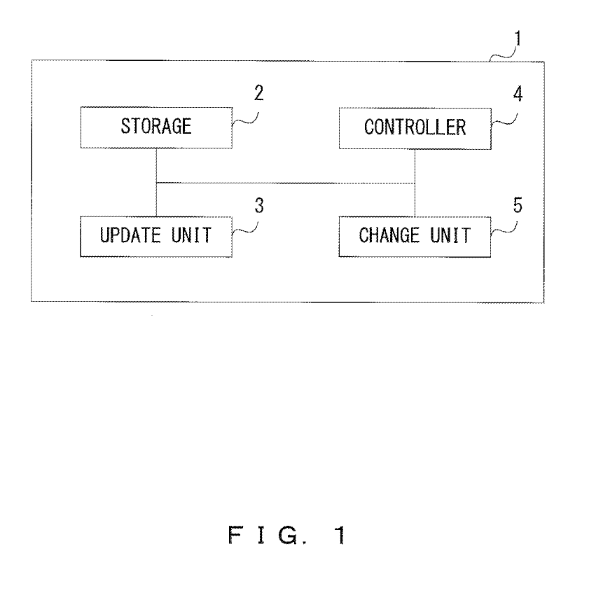

FIG. 1 is a block diagram that illustrates an example of a charging processing device according to an embodiment of the present invention. In FIG. 1, a charging processing device 1 includes a storage 2, an update unit 3, a controller 4, and a change unit 5.

The storage 2 stores therein remainder information that represents the remainder with respect to a usable amount of service. The service is, for example, a cloud service. The remainder information is, for example, a prepaid balance.

The update unit 3 updates the remainder information according to the usage amount of the service.

The controller 4 controls a timing of the next update by the update unit 3 on the basis of the updated remainder information.

This permits the charging processing device 1 to optimize an update timing for the remainder with respect to a usable amount of service.

Further, when the remainder is not greater than a prescribed threshold, the charging processing device 1 is able to prevent use of the service in excess of an allowable usable amount by performing a control for preventing use of the service. The allowable usable amount can be set in advance.

Furthermore, when the usable amount is a prepaid amount, the charging processing device 1 is able to prevent use of the service in excess of the prepaid amount.

Moreover, the charging processing device 1 is able to decrease the frequency of updating of the remainder information. This permits the charging processing device 1 to suppress a load to be imposed when performing charging processing.

The storage 2 further stores therein maximum usage amount information that represents a maximum value of the usage of the service per unit of time. The controller 4 controls a timing of the next update by the update unit 3 on the basis of the updated remainder information and the maximum usage amount information.

This permits the charging processing device according to the embodiment to more appropriately set an update timing for the remainder with respect to a usable amount of service because a timing of the next update by the update unit 3 is controlled on the basis of the updated remainder information and the maximum usage amount information.

Further, when the remainder information has been updated, the controller 4 calculates an execution time for the next update on the basis of the updated remainder information and the maximum usage amount information, and controls the update unit 3 so that the update unit 3 performs the update at the calculated execution time.

As described above, when the remainder information has been updated, the charging processing device 1 is able to more appropriately set an update timing for the remainder with respect to a usable amount of service by recalculating the next update time.

The change unit 5 changes the maximum usage amount information according to the usage pattern of the service.

When the maximum usage amount information has been changed by the change unit 5, the controller 4 calculates an execution time for the next update on the basis of the remainder information and the maximum usage amount information, and controls the update unit 3 so that the update unit 3 performs the update at the calculated execution time.

As described above, when the maximum usage amount information has been updated, the charging processing device 1 is able to more appropriately set an update timing for the remainder with respect to a usable amount of service by recalculating the next update time.

Further, when the remainder information is not greater than a prescribed threshold, the controller 4 calculates an execution time for the next update on the basis of a predetermined set value, and controls the update unit 3 so that the update unit 3 performs the update at the calculated execution time.

As described above, the charging processing device 1 calculates an execution time for the next update on the basis of a predetermined set value when remainder information is not greater than a prescribed threshold, so it is possible to prevent a usage charge calculation interval from being minimized

The update unit 3 calculates a usage charge according to the usage amount of the service, deducts the calculated usage charge from the remainder information, and newly calculates the remainder information. The usage charge is a value calculated on the basis of a unit price of a usage charge preset according to the usage pattern of one of a virtual machine, a storage, a database, a network, or an amount of data transfers, or the usage pattern of any prescribed combination of the foregoing.

Charging processing according to an embodiment of the present invention will now be described in detail. In order to explain the advantage of the embodiment, first, prepaid charging processing according to a comparative example will be described. Then, the charging processing according to the embodiment will be described, so as to indicate that the embodiment provides the advantage compared to the comparative example.

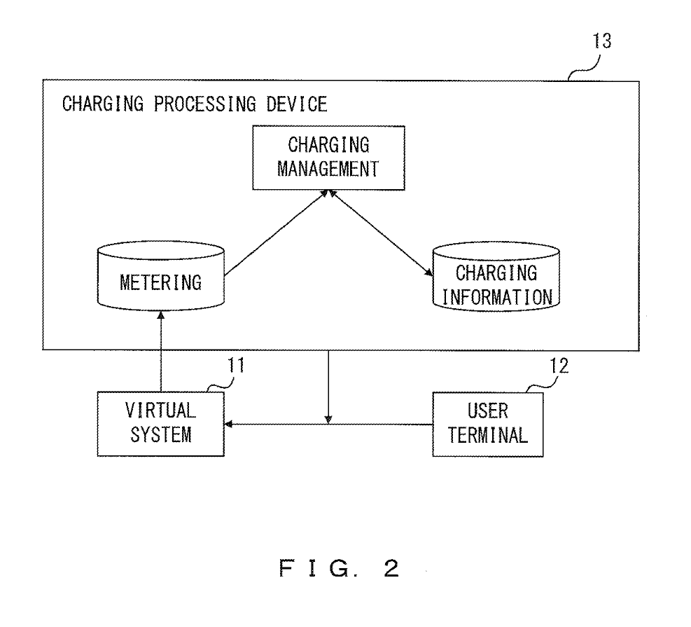

FIG. 2 is a block diagram that illustrates charging processing according to a comparative example. A charging processing system of FIG. 2 is an example of providing a virtual system 11 to a user. The charge processing system includes the virtual system 11, a user terminal 12, and a charging processing device 13. The virtual system 11, the user terminal 12, and the charge processing device 13 are connected to one another via, for example, a communication network. The virtual system 11 is an example of a service that is provided to a user, and is a system that includes, for example, a virtual server, a virtual storage, and a virtual network. The user terminal 12 is a terminal operated by the user who uses the virtual system 11. The charging processing device 13 is a device that performs charging processing on the user. A usage charge for the virtual system 11 prepaid by the user (hereinafter referred to as “prepaid balance”) is stored in advance in a storage area of the charging processing device 13.

The charging processing device 13 of the comparative example performs charging processing as follows. First, the charging processing device 13 acquires data that represents utilization of the virtual system 11 by the user (metering) and stores it in a database. Next, the charging processing device 13 regularly calculates a usage charge of the user on the basis of his/her past usage. Then, the charging processing device 13 updates the prepaid balance of the user by deducting the calculated usage charge from the prepaid balance. When the prepaid balance is less than one, the charging processing device 13 performs a stop control on the use of the service by the user. When the prepaid balance is not less than one, the service continues to be used without any change.

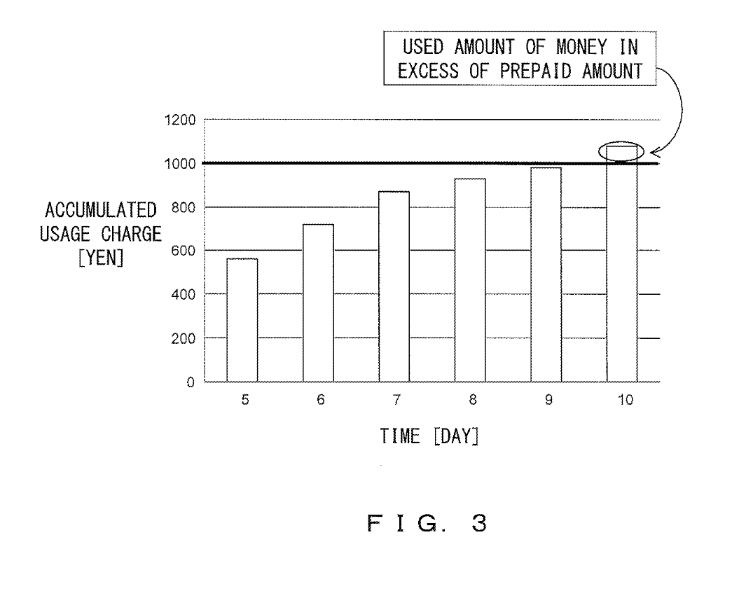

In the comparative example, a usage charge is calculated regularly (for example, once a day). Thus, the amount of money used for the service may exceed a prepaid balance. FIG. 3 is a graph that illustrates a case in which the amount of money used for the service exceeds a prepaid balance according to the comparative example. In FIG. 3, the axis of abscissas indicates a time (day) when a usage charge is calculated, and the axis of ordinate indicates an accumulated used amount of money (yen). When a prepaid amount is “1000” yen, a used amount of money reaches the prepaid amount between the times for calculating usage charges of the “9th” day and the “10th” day, and the service has been used in excess of “1000” yen, the prepaid amount, when the used amount of money is calculated on the “10th” day.

When the used amount of money exceeds the prepaid amount, it is difficult for a service provider to cover the exceeded charge. In this case, the exceeded charge is often covered by a user. As described above, a prepaid charging is not realized in a precise sense in the comparative example.

Further, in the comparative example, it is possible to increase the accuracy of the occurrence prediction of excess usage by increasing the frequency of a calculation of a usage charge that is performed regularly. However, in this case, the load imposed on a system, too, is increased if a charging calculation is performed more frequently. Thus, there is a possibility that the frequency of a charging calculation is not increased uniformly for all the virtual systems 11 on which the charging processing device 13 performs charging processing.

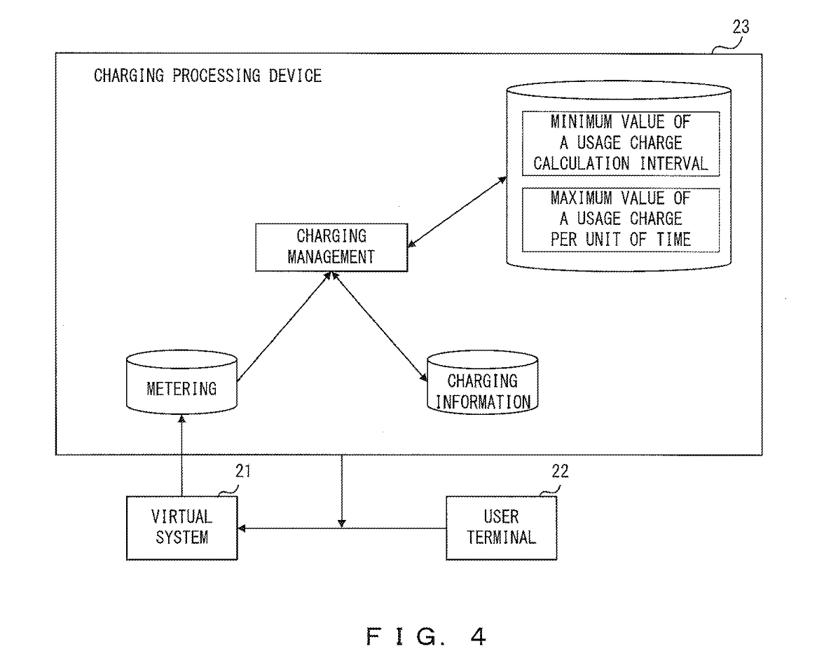

Next, charging processing according to the embodiment of the present invention will be described. FIG. 4 is a block diagram that illustrates charging processing according to the embodiment. In the following description, a prepaid balance is represented by an amount of money. However, for example, a prepaid balance may be a point that can be changed to money and may be represented in various forms. Further, the prepaid balance will be described as a usage charge that has been paid by a user in advance, but it may be a prescribed value that represents a usable amount of service. In this case, it is not a problem if the payment of a charge by the user is made before using the service, and the usage charge may be paid after using the service.

A charging processing system of FIG. 4 represents an example of providing a virtual system 21 to a user. The charging processing system includes a virtual system 21, a user terminal 22, and a charging processing device 23. The virtual system 21, the user terminal 22, and the charging processing device 23 are connected to one another via for example, a communication network. The virtual system 21 and the user terminal 22 are similar to the virtual system 11 and the user terminal 12 of FIG. 2.

The charging processing device 23 is a device that performs charging processing on a user. In the charging processing of the embodiment, timings of calculating a usage charge of a user and updating a prepaid balance of the user are appropriately controlled. The charging processing device 23 of the embodiment performs charging processing as follows.

The charging processing device 23 stores in advance, in a prescribed storage area, a minimum value of a usage charge calculation interval for each user. Further, the charging processing device 23 stores, in the prescribed storage area, a maximum value of a usage charge per unit of time that may occur by using the virtual system 21.

The charging processing device 23 calculates, from a prepaid balance and the maximum value of a usage charge per unit of time that are stored in the storage area, a candidate time interval until the next usage charge is calculated (hereinafter referred to as “candidate time”). The calculation of a candidate time will be described below in detail.

The charging processing device 23 compares the minimum value of a usage charge calculation interval with the candidate time, and determines, as a result of the comparison, a larger value (either value when those are the same) to be a time interval until the next usage charge is calculated. Then, the charging processing device 23 sets a time obtained by adding the time interval until the next usage charge is calculated to a current time as a time to calculate the next usage charge (hereinafter referred to as “next calculation time”), and stores it. The reason for comparing a minimum value of a usage charge calculation interval with a candidate time will be described below.

The charging processing device 23 meters utilization of the virtual system 21 until the calculated next calculation time. On the basis of information acquired by performing the metering, the charging processing device 23 detects a change in the maximum value of a usage charge per unit of time, and recalculates the next calculation time. The maximum value of a usage charge per unit of time is changed when, for example, there is a change in the configuration of the virtual system 21, an addition or return of resources of the virtual system 21 by a user, or a change in the price for using the virtual system 21. Thus, in this case, the charging processing device 23 recalculates the maximum value of a usage charge per unit of time, and calculates the next calculation time by use of the recalculated maximum value of a usage charge and the prepaid balance.

Further, when an addition to the prepaid balance is performed by prepayment of a usage charge by a user by the next calculation time, the charging processing device 23 recalculates the next calculation time using the prepaid balance including the addition and the maximum value of a usage charge.

At the next calculation time, the charging processing device 23 calculates a usage charge on the basis of a past usage. After that, the charging processing device 23 deducts the calculated usage charge from the prepaid balance of the user, so as to update the balance. When the balance is less than one, the charging processing device 23 performs a stop control on the use of the service by the user. When the balance is not less than one, the service continues to be used without any change.

As described above, according to the embodiment, a maximum value of a usage charge per unit of time that may occur when a user uses the virtual system 21 is calculated in advance. Then, a calculation interval is adjusted for each virtual system 21 on the basis of the calculated maximum value of a usage charge and a prepaid balance. This prevents the virtual system 21 from being used in excess of a prepaid amount. Further, according to the embodiment, when there is a change in a maximum value of a usage charge or a prepaid balance or both, the next calculation time is recalculated and updated. This prevents the virtual system 21 from being used in excess of a prepaid amount, and this permits a reduction in the frequency of a calculation of a usage charge. Compared with the comparative example, the embodiment permits a reduction in the load imposed on a system because the frequency of a calculation of a usage charge can be reduced.

Next, the calculation of a candidate time will be described in detail. A candidate time is calculated using Formula (1) as follows:

Candidate time=prepaid balance/maximum value of a usage charge per unit of time (1)

According to Formula (1), the candidate time is calculated as a value represented by a time interval that makes the prepaid balance less than “one” when the virtual system 21 is used at the maximum usage charge per unit of time.

When the next calculation time is set by use of the candidate time, a usage charge is calculated at the set next calculation time, and the prepaid balance is updated by use of the calculated usage charge. When the prepaid balance is less than “one” after the prepaid balance is updated, a stop control is performed on the use of the service. This prevents the service from being used in excess of a prepaid amount even when the virtual system 21 is used at the maximum usage charge per unit of time.

When a value is not divisible in Formula (1), a value that is rounded down to a prescribed decimal place may be set as a candidate time.

Next, the reason for comparing a minimum value of a usage charge calculation interval and a candidate time in the embodiment will now be described.

According to Formula (1), a value of a candidate time is smaller if a prepaid balance is closer to “zero”. When the value of a candidate time is small, an interval until the next calculation time is short and the load of a charge calculation is high if a time obtained by adding the candidate time to a current time is set as the next calculation time. In order to avoid such an increase in the load of a charge calculation, the minimum value of the next usage charge calculation interval is set in advance in the embodiment. Then, when the calculated value of the candidate time is smaller than the minimum value of a usage charge calculation interval, a time interval until the next usage charge calculation is determined to be a minimum value of a usage charge calculation interval. This prevents the usage charge calculation interval from being minimized.

When performing a process for preventing the usage charge calculation interval from being minimized, a maximum value of amount of money obtained by use of “<maximum value of a usage charge per unit of time>×<minimum value of a usage charge calculation interval>−1” may exceed a prepaid amount. Here, “1” represents a minimum value of a currency for a usage charge. For example, when a usage charge is in yen, it refers to “¥1”, and when the usage charge is in dollars, it corresponds to “¢1(=$0.01)”.

Also, in this case, it is possible to make an excess charge “zero” by appropriately setting the minimum value of a usage charge calculation interval. In other words, it is possible to make an excess charge “zero” if the minimum value of a usage charge calculation interval is set by use of “<minimum value of a usage charge calculation interval>=1/<maximum value of a usage charge per unit of time>”. In concrete terms, for example, when the maximum value of a usage charge per unit of time is 100[yen], it is possible to avoid usage in excess of a prepaid amount by setting the minimum value of a usage charge calculation interval to 0.01[H]. In other words, “100[yen]×0.01[H]−1=0” is possible.

The minimum value of a usage charge calculation interval may be, for example, a value calculated on the basis of a prepaid balance and a maximum value of a usage charge per unit of time. In this case, the charging processing device may calculate the minimum value of a usage charge calculation interval every time it sets the next calculation time.

Further, the minimum value of a usage charge calculation interval may be set for each user. According to the embodiment, the frequency of a calculation of a usage charge can be adjusted for each user by setting the minimum value of a usage charge calculation interval for each user.

Even when usage exceeds a prepaid amount at the time of the last usage charge calculation before a stop control is performed, it is possible to make an amount of money for excess usage small. It is possible to avoid the occurrence of an additional charging in a service user by setting the minimum value of a calculation interval so that the amount of money for excess usage can be charged to a service provider. The prepaid charging according to the embodiment permits an appropriate setting of a usage charge calculation interval while balancing between the load imposed on a system for calculating a usage charge and an amount of excess charge that may occur.

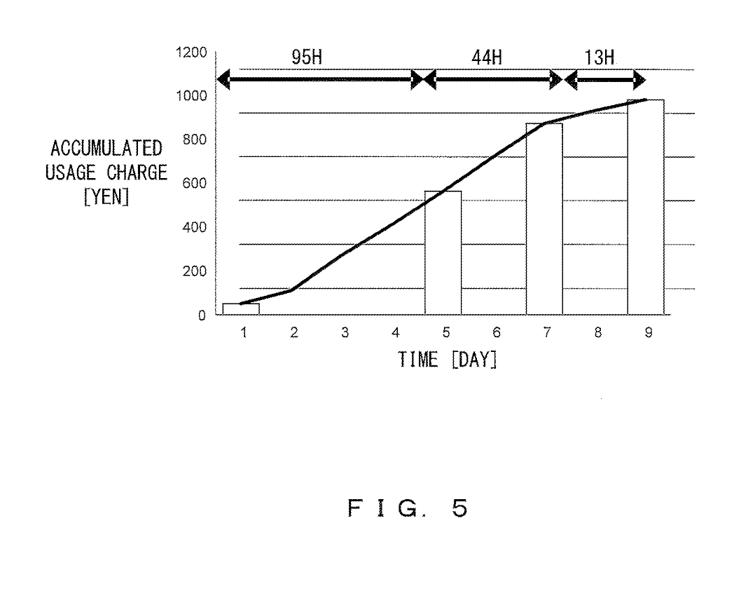

FIG. 5 is a graph that illustrates a prevention of excess usage according to the embodiment. In FIG. 5, the axis of abscissas indicates a time (day) when a usage charge is calculated, and the axis of ordinate indicates an accumulated used amount of money (yen). A line represents an actual usage charge, and a bar represents a calculated usage charge. A prepaid amount is “1000” yen. A usage charge is not calculated at a time (on a day) without bar.

As illustrated in FIG. 5, a usage charge is calculated on the “first” day, the “fifth” day”, the “seventh” day, and the “ninth day” in the embodiment, and compared with the comparative example of FIG. 3, the frequency of a calculation of a usage charge is reduced. In this way, the embodiment permits a reduction in the load of a usage charge calculation. Further, a usage charge calculation interval is smaller if an accumulated usage charge is closer to a prepaid amount, “1000” yen. In this way, the embodiment permits preventing of usage in excess of a prepaid amount.

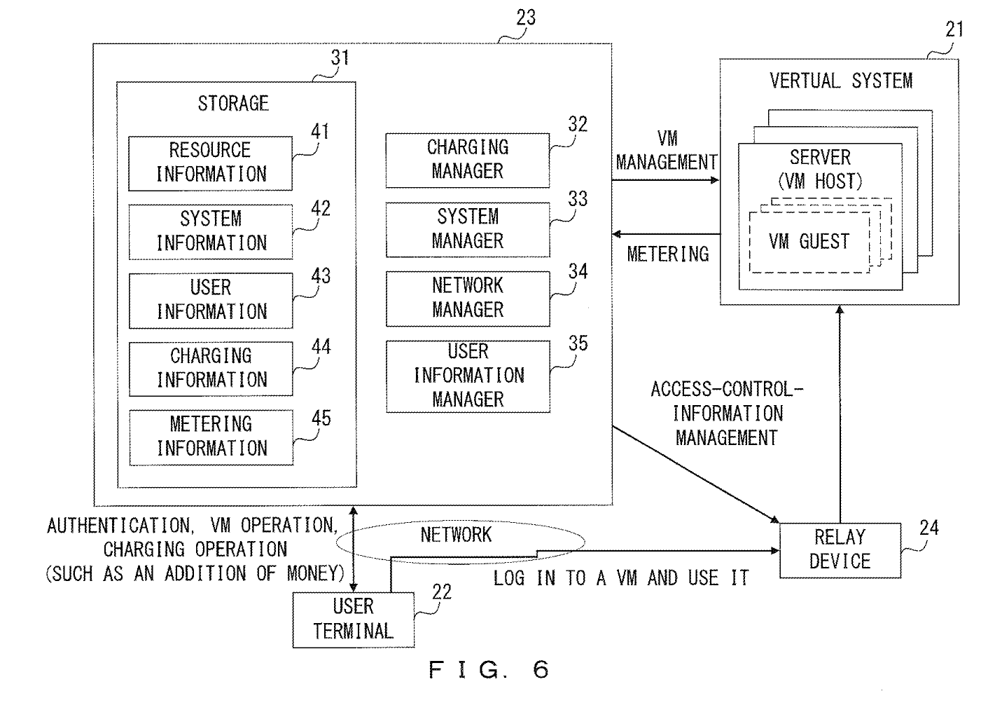

Next, the configuration of the charging processing device 23 will be described in detail. FIG. 6 is a block diagram that illustrates an example of a charging processing system according to the embodiment. A charging processing system includes the virtual system 21, the user terminal 22, the charging processing device 23, and a relay device 24. The virtual system 21, the user terminal 22, the charging processing device 23, and the relay device 24 are connected to one another via, for example, a communication network.

The virtual system 21 may include, for example, one of a physical server, a storage, a network device, a virtual server (a virtual machine (VM) host and a VM guest), a virtual storage, or a virtual network, or any prescribed combination of the foregoing.

The relay device 24 relays communication between the virtual system 21 and the user terminal 22. The user terminal 22 uses resources in the virtual system 21 by logging in to, for example, a virtual server in the virtual system 21. In particular, the relay device 24 is, for example, a router.

In the embodiment, a user uses a cloud service for each system.

The charging processing device 23 includes a storage 31, charging manager 32, a system manager 33, a network manager 34, and a user information manager 35.

The charging processing device 23 is an example of the charging processing device 1 of FIG. 1. The storage 31 is an example of the storage 2 of FIG. 1. The charging manager 32 is an example of the update unit 3 and the controller 4 of FIG. 1. The charging manager 32 and the system manager 33 are an example of the change unit 5.

The storage 31 stores therein resource information 41, system information 42, user information 43, charging information 44, and metering information 45.

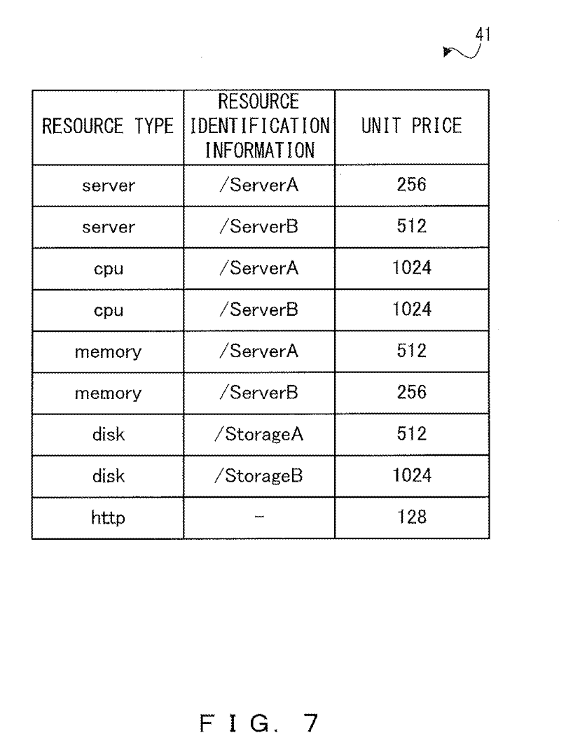

The resource information 41 is information that represents a unit price for each resource that is provided to a user. FIG. 7 is a table that illustrates an example of the resource information 41. In FIG. 7, the resource information 41 includes data items that are a “resource type”, “resource identification information”, and a “unit price”, and the data items are stored in association with one another for each record (row).

The “resource type” is information that represents a type of resources that can be provided to a user. The “resource identification information” is identification information on a resource of a type of resources that is represented by a corresponding “piece of resource information”. For example, the “resource identification information” is represented by identification information on a server pool or a storage pool that includes a corresponding resource. The “unit price” is information that represents a unit price of a resource of the resource type represented by the corresponding “piece of resource information”, the resource being represented by a corresponding “piece of resource identification information”.

The resource information 41 is not restricted to the example of FIG. 7, and may include various data items in accordance with the resource provided to a user.

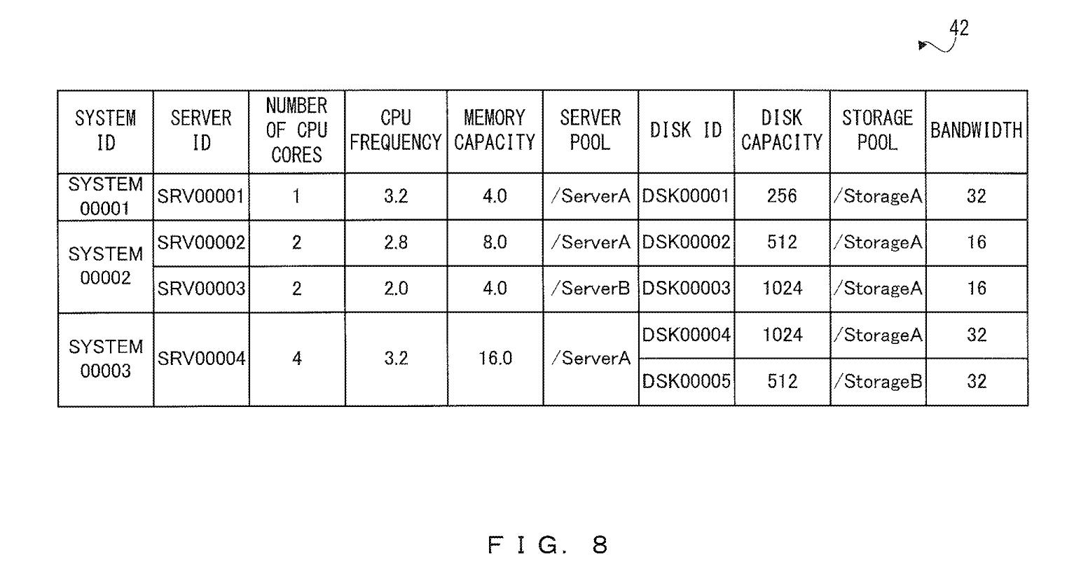

The system information 42 is information that represents a configuration of a system provided to a user. FIG. 8 is a table that illustrates an example of system information 42. In FIG. 8, the system information 42 includes data items that are a “system ID”, a “server ID”, the “number of CPU cores”, a “CPU frequency”, a “memory capacity”, a “server pool”, a “disk ID”, a “disk capacity”, a “storage pool”, and a “bandwidth”. The data items in the system information 42 are associated with one another for each record.

The “system ID” is identification information on a system provided to a user. The “server ID” is identification information on a server included in the system represented by the “system ID”. The “number of CPU cores” is information that represents the number of cores of a central processing unit (CPU) included in the server represented by the “server ID”. The “CPU frequency” is information that represents the frequency of the CPU included in the server represented by the “server ID”. The “memory capacity” is information that represents a capacity of memory included in the server represented by the “server ID”. The “server pool” is identification information on a server pool including the server represented by the “server ID”. The “disk ID” is identification information on a disk included in the system represented by the “system ID”. The “disk capacity” is information that represents a disk capacity of the disk represented by the “disk ID”. The “storage pool” is identification information on a storage pool including the disk represented by the “disk ID”. The “bandwidth” is information that represents a bandwidth of a network included in the system represented by the “system ID”.

The system information 42 is not restricted to the example of FIG. 8, and may include various data items in accordance with a configuration of a system.

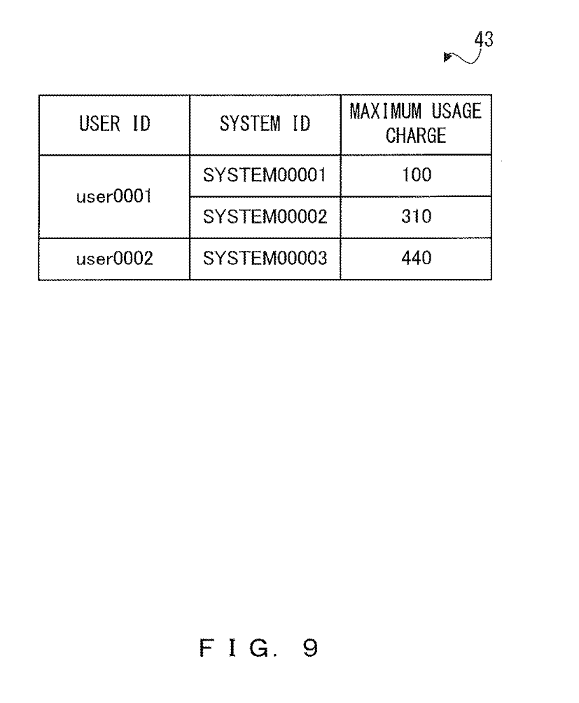

The user information 43 is information in which, for each user, identification information on a system that is used by a user is associated with a maximum usage charge per unit of time. FIG. 9 is a table that illustrates an example of user information 43. In FIG. 9, user information 43 includes data items that are a “user ID”, a “system ID”, and a “maximum usage charge”, and the data items are associated with one another for each record. The “user ID” is identification information on a user. The “system ID” is identification information on a system used by the user represented by the “user ID”. The “system ID” in the user information 43 corresponds to the “system ID” in the system information 42. The “maximum usage charge” is information that represents the maximum value of a usage charge per unit of time in the system represented by the “system ID”. The “maximum usage charge”, that is, the maximum value of a usage charge per unit of time is an example of maximum usage amount information.

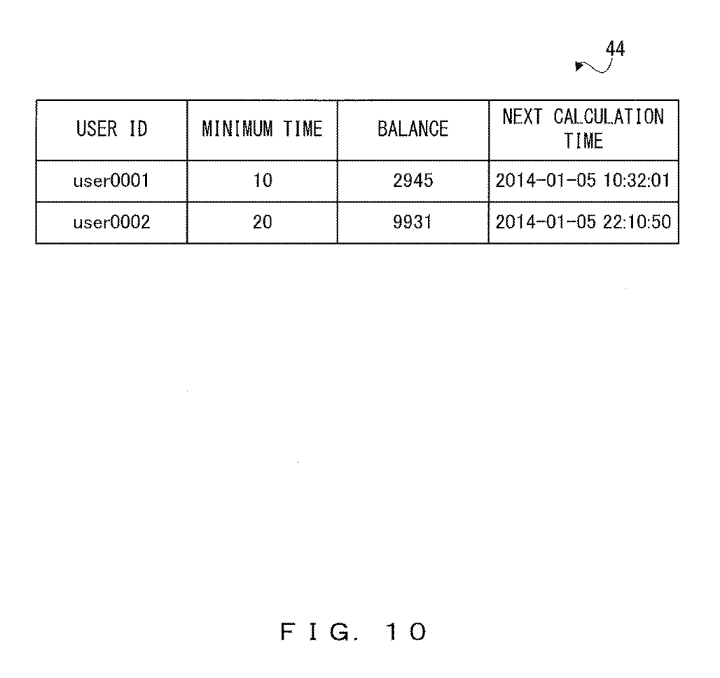

The charging information 44 is information in which, for each user, a minimum value of a usage charge calculation interval, a prepaid balance, and the next calculation time are associated with one another. FIG. 10 is a table that illustrates an example of charging information 44. In FIG. 10, the charging information 44 includes data items that are a “user ID”, a “minimum time”, a “balance”, and the “next calculation time”, and the data items are associated with one another for each record. The “user ID” is identification information on a user. The user ID” in the charging information 44 corresponds to the “user ID” in the user information 43. The “minimum time” is information that represents a minimum value of a usage charge calculation interval that has been set to the user represented by the “user ID”. The value of the “minimum time” is a predetermined set value. The “balance” is information that represents a prepaid balance of the user represented by the “user ID”. The “balance” is an example of remainder information. The “next calculation time” is information that represents the next calculation time for the user represented by the “user ID”.

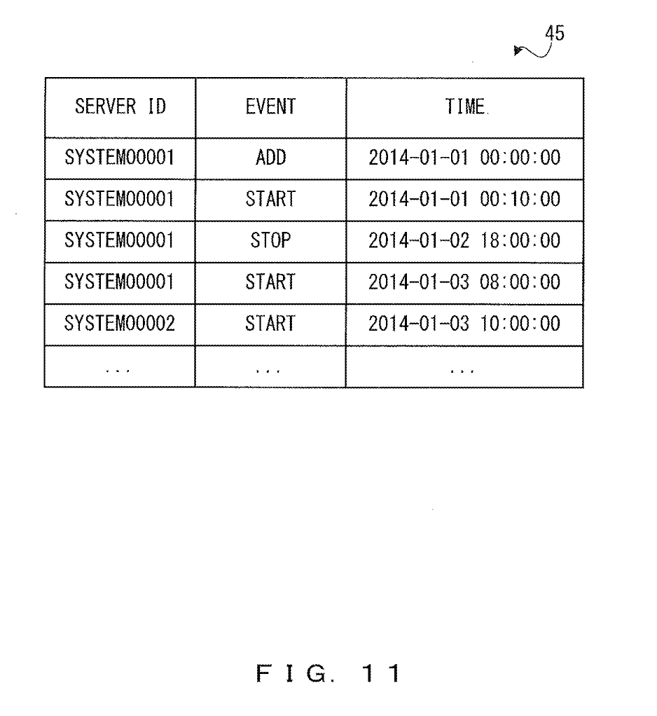

The metering information 45 is information that stores therein an arrangement status and an operational status of the virtual system 21 (including a server, a storage, a network, and each resource), and that is acquired by metering utilization of the system for each user. FIG. 11 is a table that illustrates an example of metering information 45. In FIG. 11, the metering information 45 includes data items that are a “server ID”, an “event”, and a “time”, and the data items are stored in association with one another for each record.

The “server ID” is identification information on a server. The “server ID” in the metering information 45 corresponds to the “server ID” in the system information 42. The “event” is information that represents an event that has occurred with respect to the server represented by the “server ID”. The “time” is information that represents a time when the event represented by the “event” has occurred with respect to the server represented by the “server ID”.

The data items in the metering information 45 are not restricted to what is illustrated in FIG. 11. The metering information 45 may include, for example, an average CPU utilization, an average memory utilization, a minimum memory utilization, and a maximum memory utilization that are associated with one another for each system or for each resource. Further, the metering information 45 may include pieces of information, such as a maximum amount of disk area that has been allocated to a virtual machine, a total received network traffic amount, and a total transmitted network traffic amount, that are associated with one another for each system or for each resource.

The charging manager 32 performs processing on charging. In concrete terms, the charging manager 32 performs processes of calculating a maximum usage charge per unit of time, calculating the next calculation time, calculating a usage charge, and updating a balance. Each of the processes performed by the charging manager 32 will be described below.

First, the process of calculating a maximum usage charge per unit of time will be described. In the process of calculating a maximum usage charge per unit of time, the charging manager 32 calculates a maximum usage charge per unit of time for each user, and stores the calculated value in “MAXIMUM USAGE CHARGE” of a record corresponding to each of the users in the user information 43.

In concrete terms, the charging manager 32 calculates a maximum usage charge per unit of time for each user on the basis of a configuration of a system used by a user and on the basis of unit prices of resources included in the system. In other words, the charging manager 32 calculates a maximum usage charge per unit of time on the basis of the resource information 41, the system information 42, and the metering information 45. The charging manager 32 associates the calculated maximum usage charge with identification information on the user and identification information on the system, and stores it in the user information 43.

The calculation of a maximum usage charge per unit of time will be instantiated below. In this case, it is assumed that a user A uses a system A that includes one virtual machine, one virtual disk (500 GB), and a bandwidth of 32 Mbps. Such information is stored in the system. information 42 in advance. Further, unit prices of the respective resources are 10[yen/H] for use of the virtual machine in an activated state, 0.01[yen/(H*GB)] for use of the virtual disk in an arranged state, and 15[yen/GB] for use of HTTP communication. Such information is stored in the resource information 41 in advance. Furthermore, all the resources included in the system A are in an arranged state and are in operation. Such information is stored in the metering information 45.

The charging manager 32 refers to the resource information 41 and the system information 42, and acquires information on the system A and information on a unit price of each of the resources included in the system A. The charging manager 32 refers to the metering information 45, and acquires an operational status or an arrangement status of each of the resources included in the system A. Then, the charging manager 32 performs calculation as follows, so as to calculate a maximum usage charge per unit of time. In this description, the unit of time is one hour. The charging manager 32 calculates “10 [yen/H]*1[virtual machine]=10[yen/H]” for a usage charge for the virtual machine. The charging manager 32 calculates “0.01 [yen/(H*GB)]*500 [GB]*1 [virtual disk]=5 [yen/H]” for a usage charge for the virtual disk. The charging manager 32 calculates “15 [yen/GB]*((32 [Mbps]/(8*1000))*3600 [sec])=216 [yen/H]” for a usage charge for HTTP communication. Then, the charging manager 32 calculates “10+5+216=231 [yen/H]” as the maximum usage charge per unit of time.

Next, the process of calculating the next calculation time will be described. In the process of calculating the next calculation time, first, the charging manager 32 calculates a candidate time using Formula (1) described above. In concrete terms, the charging manager 32 refers to a value of “BALANCE” in the charging information 44 so as to acquire a prepaid balance of a user whose next calculation time is to be calculated. Then, using the acquired prepaid balance and the maximum usage charge per unit of time calculated as above, the charging manager 32 calculates a candidate time by use of Formula (1). Next, the charging manager 32 refers to a value of “MINIMUM TIME” in the charging information 44, so as to acquire the minimum value of a usage charge calculation interval for the target user. Next, the charging manager 32 compares the acquired minimum value of a usage charge calculation interval with the candidate time, and determines, as a result of the comparison, a larger value (either value when those are the same) to be a time interval until the next usage charge is calculated. Then, the charging manager 32 sets, as the next calculation time, a time obtained by adding the time interval until the determined next usage charge is calculated to a current time, and stores it in “NEXT CALCULATION TIME” in a record of the target user in the charging information 44.

Next, the process of calculating a usage charge will be described. The process of calculating a usage charge is performed at the time represented by the next calculation time. In concrete terms, the charging manager 32 monitors the “next calculation time” in a record of the user in the charging information 44, and performs the process of calculating a usage charge when the current time has become the time represented by the “next calculation time”.

In the process of calculating a usage charge, the charging manager 32 refers to the metering information 45, and acquires the past usage of the user whose usage charge is to be calculated. Then, the charging manager 32 calculates the usage charge on the basis of the acquired past usage and the resource information 41. In concrete terms, for example, first, the charging manager 32 acquires, from the metering information 45, a value of a past usage of each of the resources included in the system that has been used by the user. Each of the resources is, for example, a virtual machine, a storage, a database, or a network, and the system used by the user may include one of the resources, or any prescribed combination of the foregoing. The value of the past usage of each of the resources may includes, for example, an amount of data transfers, a disk utilization, a memory utilization, or a CPU utilization. Next, the charging manager 32 acquires, from the resource information 41, a unit price of each of the resources included in the system that has been used by the user. Then, the charging manager 32 multiplies the past usage by the unit price for each resource included in the system that has been used by the user, and calculates, as a usage charge, a value obtained by adding up the values for all the resources that are obtained by the multiplication.

Next, the process of updating a balance will be described. The process of updating a balance is performed after the process of calculating a usage charge is performed, or when the user has prepaid a usage charge.

In the process of updating a balance performed after the process of calculating a usage charge is performed, first, the charging manager 32 refers to “BALANCE” in a record of the user in the charging information 44, and acquires the prepaid balance of the user. Next, the charging manager 32 deducts, from the acquired prepaid balance, the usage charge calculated in the process of calculating a usage charge. Then, the charging manager 32 stores, in “BALANCE” of the charging information 44, a prepaid balance obtained by the deduction as a new prepaid balance.

In the process of updating a balance performed when the user has prepaid a usage charge, the charging manager 32 acquires information that represents the amount prepaid by the user. Further, the charging manager 32 refers to “BALANCE” in a record of the user in the charging information 44, and acquires the prepaid balance of the user. Next, the charging manager 32 adds the acquired prepaid amount to the acquired prepaid balance. Then, the charging manager 32 stores, in “BALANCE” of the charging information 44, a prepaid balance to which the prepaid amount has been added as a new prepaid balance.

The prepayment of a usage charge made by the user may be performed, for example, through an addition of money that has been added to an account of the user. In this case, the charging manager 32 may acquire information that represents the amount prepaid by the user, by receiving information on money being added to the account of the user via, for example, a communication network from a system that has received the addition of money and manages other additions of money.

The system manager 33 manages the entirety of the service of the virtual system 21. When the configuration of the virtual system 21 has been changed, the system manager 33 reflects information on the changed configuration in the resource information 41 and the system information 42. When the configuration of the virtual system 21 has been changed, the system manager 33 detects the change in the system configuration by receiving a report from the user information manager 35. The change in the system configuration includes a change in a unit price of each of the resources included in the system.

The network manager 34 performs a stop control on the use of the virtual system 21 by the user terminal 22 when the prepaid balance has been exhausted. In concrete terms, for example, the network manager 34 monitors a value in “BALANCE” in the charging information 44, and when the value in “BALANCE” is less than “one”, it performs a stop control on the use of the virtual system 21 by the user of that record. In the stop control on the use of the virtual system 21, for example, the network manager 34 may control the relay device 24 that relays communication between the user terminal 22 and the virtual system. 21, so as to change an access control or a routing table in the relay device 24. Further, in the stop control on the use of the virtual system 21, for example, the network manager 34 may delete or change a virtual LAN (VLAN) allocated to the user. The stop control performed by the network manager 34 on the use of the virtual system 21 may be, for example, a process of reminding the user by reporting the occurrence of an excess of a usage charge to the user terminal 22.

The user information manager 35 acquires information by metering utilization of the virtual system 21 (for example, a server, a storage, a network, and each resource) for each user, and stores the information in the metering information 45. For example, the user information manager 35 acquires an arrangement status and an operational status of the virtual system 21 and stores them in the metering information 45.

Further, the user information manager 35 may acquire information on a past usage of each of the resources included in the virtual system 21, that is, information on a CPU utilization, a disk utilization, or a network utilization, so as to store it in the metering information 45.

Further, the user information manager 35 detects a change in the configuration of the virtual system 21 on the basis of the information acquired by performing the metering. Then, to the system manager 33, the user information manager 35 reports that the system configuration has been changed and also reports information that represents the change.

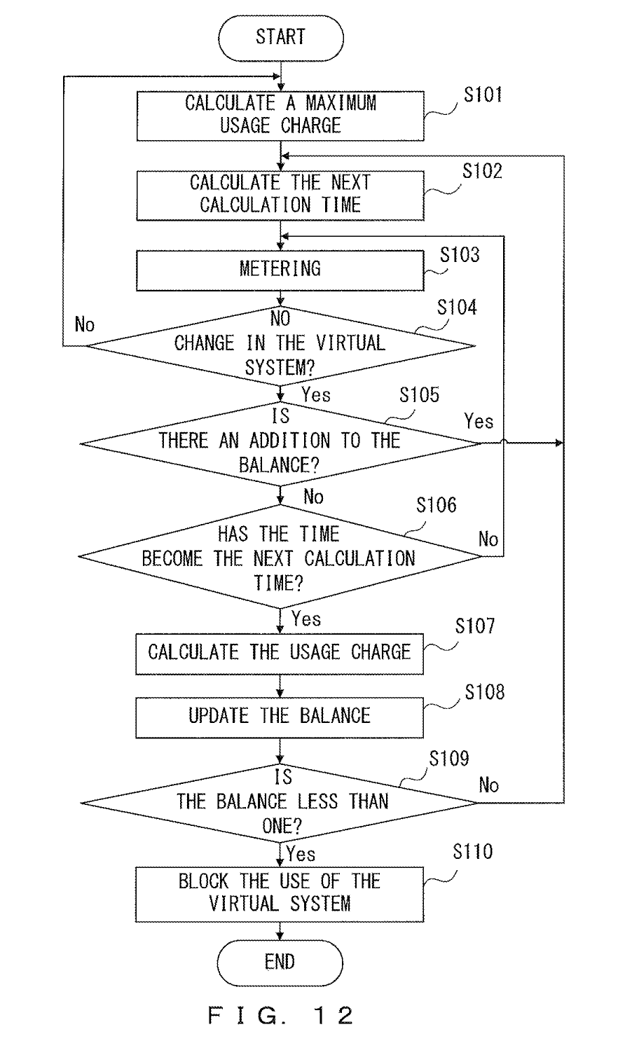

Next, a flow of processing performed by the charging processing device 23 according to the embodiment will be described. FIG. 12 is a flowchart that illustrates in detail an example of processing performed by the charging processing device 23 according to the embodiment. In the flow of FIG. 12, a user on whom charging processing is to be performed is referred to as “target user”. Further, in the flow of FIG. 12, a user has applied for using a virtual system and has charged his/her prepaid balance before the processing starts.

In FIG. 12, first, the charging manager 32 performs the process of calculating a maximum usage charge per unit of time for a target user (S101). In other words, the charging manager 32 calculates a maximum usage charge per unit of time for a target user on the basis of the resource information 41, the system information 42, and the metering information 45.

Next, the charging manager 32 performs the process of calculating the next calculation time for the target user (S102). In concrete terms, first, the charging manager 32 calculates a candidate time by use of Formula (1), using the maximum usage charge per unit of time for the target user that has been calculated in S101, and the prepaid balance for the target user. Then, the charging manager 32 compares a minimum value of a usage charge calculation interval for the target user with the candidate time, and calculates a time obtained by adding a larger value to a current time (the time of the process of S102) as the next calculation time.

Next, the user information manager 35 performs metering, acquires utilization of the virtual system 21 for each user, and stores in the metering information 45 (S103).

Next, the user information manager 35 determines, on the basis of the information acquired by performing the metering, whether there is a change in the configuration of the virtual system 21 (S104). When it has been determined that there is a change in the configuration of the virtual system 21 (No in S104), the process moves on to S101 again, and the process of calculating a maximum usage charge per unit of time is performed.

On the other hand, when it has been determined that there is no change in the configuration of the virtual system 21 (Yes in S104), the charging manager 32 determines whether the prepaid balance has been increased by the prepayment of a usage charge made by the user (S105). When it has been determined that the prepaid balance has been increased (Yes in S105), the process moves on to S102 again, and the process of calculating the next calculation time is performed again.

On the other hand, when it has been determined that the prepaid balance has not been increased (No in S105), the charging manager 32 determines whether the current time (the time of the process of S106) has become the next calculation time calculated in S102 (S106). When it has been determined that the current time has not become the next calculation time (No in S106), the process moves on to S103 again, and metering is performed.

On the other hand, when it has been determined that the current time has become the next calculation time (Yes in S106), the charging manager 32 performs the process of calculating a usage charge (S107). In other words, for example, the charging manager 32 calculates a usage charge on the basis of a past usage acquired from the metering information 45 and on the basis of a unit price of each of the resources acquired from the resource information 41.

Next, the charging manager 32 performs the process of updating a balance that is to be performed after the process of calculating a usage charge is performed (S108). In concrete terms, the charging manager 32 deducts the usage charge calculated in S107 from the prepaid balance, and sets a prepaid balance obtained by the deduction as a new prepaid balance.

Next, the network manager 34 determines whether the prepaid balance is less than “one” (S109). When it has been determined that the prepaid balance is not less than “one” (No in S109), the process moves on to S102 again, and the next calculation time is calculated.

On the other hand, when it has been determined that the prepaid balance is less than “one” (Yes in S109), the network manager 34 performs a stop control on the use of the virtual system 21 (S110). Then, the processing ends.

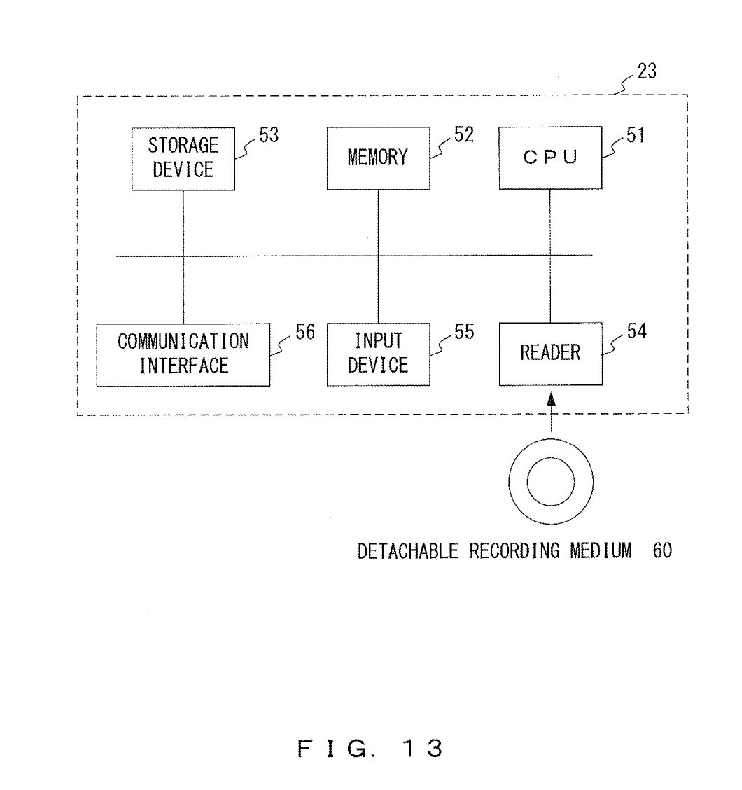

Next, an example of a hardware configuration of the charging processing device 23 according to the embodiment will be described. FIG. 13 is block diagram that illustrates an example of a hardware configuration of the charging processing device 23 according to the embodiment.

In FIG. 13, the charging processing device 23 includes a CPU 51, a memory 52, a storage device 53, a reader 54, an input device 55, and a communication interface 56. The CPU 51, the memory 52, the storage device 53, the reader 54, the input device 55, and the communication interface 56 are connected to one another via, for example, a bus.

The CPU 51 provides some of or the entirety of the functions of the charging manager 32, the system manager 33, the network manager 34, and the user information manager 35 by executing a program in which a procedure of the flowchart described above has been written by use of the memory 52.

The memory 52 is, for example, a semiconductor memory, and is structured including a random access memory (RAM) area and a read only memory (ROM) area. The memory 52 provides some of or the entirety of the functions of the storage 31. The storage device 53 is, for example, a hard disk. The storage device 53 may be a semiconductor memory such as a flash memory. The storage device 53 may be an external recording device. The storage device 53 may provide the functions of the storage 31.

The reader 54 accesses a detachable recording medium 60 in accordance with instructions issued by the CPU 51. For example, the detachable recording medium 60 is realized by a semiconductor device (such as a USB memory), a medium to/from which information is input/output by magnetic action (such as a magnetic disk), and a medium to/from which information is input/output by optical action (such as a CD-ROM and a DVD). It is not a problem if the reader 54 is not included in the charging processing device 23.

The input device 55 receives an input of a minimum value of a usage charge calculation interval for each user. It is not a problem if the input device 55 is not included in the charging processing device 23.

In accordance with instructions issued by the CPU 51, the communication interface 56 communicates with, for example, the relay device 24, the virtual system 21, and the user terminal 22 via a network. The network manager 34 connects to the relay device 24 via the communication interface 56, so as to perform a stop control on the use of the virtual system 21 by a user. The user information manager 35 acquires, by performing metering, information that represents utilization of the virtual system 21 from the virtual system 21 via the communication interface 56.

The program according to the embodiment is provided to the charging processing device 23, for example, in the following state:

(1) Preinstalled in the storage device 53
(2) Provided by the detachable recording medium 60
(3) Provided from a program server (not shown) via the communication interface 56

Further, a portion of the charging processing device 23 according to the embodiment may be realized by hardware. Alternatively, the charging processing device 23 according to the embodiment may be realized by a combination of software and hardware.

In the embodiment, hardware resources have been described as a service provided by a cloud service, but the provided service may be, for example, software.

Embodiments of the present invention are not limited to the above mentioned embodiment but are amenable to various configurations or embodiments without departing from the scope of the invention.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A charging processing device comprising:
a storage configured to store therein remainder information that represents the remainder with respect to a usable amount of service; and
a processor configured to execute a process including
updating the remainder information according to the usage amount of the service, and
controlling a timing of the next update on the basis of the updated remainder information.

2. The charging processing device according to claim 1, wherein
the storage further stores therein maximum usage amount information that represents a maximum value of the usage amount of the service per unit of time, and
the controlling controls a timing of the next update on the basis of the updated remainder information and the maximum usage amount information.

3. The charging processing device according to claim 2, wherein
when the remainder information has been updated, the controlling calculates an execution time for the next update on the basis of the updated remainder information and the maximum usage amount information, and performs a control so that the update is performed at the calculated execution time.

4. The charging processing device according to claim 2, the process further including changing the maximum usage amount information according to the usage pattern of the service, wherein
when the maximum usage amount information has been changed, the controlling calculates an execution time for the next update on the basis of the remainder information and the maximum usage amount information, and performs a control so that the update is performed at the calculated execution time.

5. The charging processing device according to claim 1, wherein
when the remainder information is not greater than a prescribed threshold, the controlling calculates an execution time for the next update on the basis of a predetermined set value, and performs a control so that the update is performed at the calculated execution time.

6. The charging processing device according to claim 1, wherein
the updating calculates a usage charge according to the usage amount of the service, deducts the calculated usage charge from the remainder information, and newly calculates the remainder information, and
the usage charge is a value calculated on the basis of a usage charge preset according to the usage pattern of one of a virtual machine, a storage, a database, a network, or an amount of data transfers, or the usage pattern of any prescribed combination of the foregoing.

7. A charging processing method comprising:
updating, by a computer, remainder information according to the usage amount of a service, the remainder information being stored in a storage that stores therein the remainder information representing the remainder with respect to a usable amount of the service; and
controlling, by the computer, a timing of the next update on the basis of the updated remainder information.

8. A non-transitory computer-readable recording medium having stored therein a program for causing a computer to execute a process comprising:
updating remainder information according to the usage amount of a service, the remainder information being stored in a storage that stores therein the remainder information representing the remainder with respect to a usable amount of the service; and
controlling a timing of the next update on the basis of the updated remainder information.
